(19) United States
(12) Patent Application Publication
(10) Pub. No.: US 2008/0040243 A1
(43) Pub. Date: Feb. 14, 2008

(54) NOTIFICATION OF MAIL DELIVERIES IN REMOTE POST OFFICE MAILBOXES

(76) Inventors: David Yu Chang, Primyork, TX (US); John Yow-Chun Chang, Austin, TX (US); Vishwanath Venkataramappa, Austin, TX (US)

Correspondence Address: IBM CORP (YA);C/O YEE & ASSOCIATES PC, P.O. BOX 802333, DALLAS, TX, 75380, US

(21) Appl. No.: 11/463,102

(22) Filed: Aug. 8, 2006

(51) Int. Cl. G06Q 10/00

(52) U.S. Cl. 705/28

(57) ABSTRACT

A computer implemented method, apparatus, and computer usable program code for mail notification. Physical mail is received in a mailbox. The physical mail includes an identifier indicating information about the physical mail. A presence of the physical mail is detected in the mailbox. The identifier is read in response to detecting the presence of the physical mail. A notification is sent to a mail recipient including the information in response to reading the identifier.

### BACKGROUND OF THE INVENTION

1. Field of the Invention

The present invention relates generally to an improved data processing system and more particularly, to a computer implemented method, apparatus, and computer usable program code for notification of mail deliveries in remote post office mailboxes.

2. Description of the Related Art

Despite the transition of many forms of communication to electronic mail, most individuals, companies, and other groups or organizations are still dependent on mail in the form of physical mail. Many people use mail for personal and business communications and transactions. In many cases, mail provides a communication service that is both necessary and important to the mail recipient. Mail is physical mail, such as postal mail, and may be delivered by the postal service or other similar contracting or delivery services.

In many cases, mail recipients receive mail in a remote mailbox. Checking the remote mailbox may require time and effort regardless of whether there is actually mail in the mailbox. For example, in many cities, an individual may have a mailbox in the nearest mail facility. The mail facility may be miles away from the location of the mail recipient. In other cases, the individual may live in a rural area with a distant mailbox.

As a result, a mail recipient has to physically travel to the mailbox to determine whether there is mail or not. Consequently, many mail recipients waste time and effort to check the mailbox when there is no mail for the recipient.

Different pieces of mail are of different importance to the mail recipient. For example, bills may be considered of high importance to the mail recipient while so called “junk” or “bulk” mail for a sweepstakes may be of no importance. In some cases, a mail recipient may spend time and effort to check the contents of the mailbox without knowing whether any of the information of the delivered mail provides value to the recipient. In many cases, the mail recipient may feel that time is wasted checking the mailbox to retrieve low importance mail.

### SUMMARY OF THE INVENTION

The illustrative embodiments provide a computer implemented method, apparatus, and computer usable program code for mail notification. Physical mail is received in a mailbox. The physical mail includes an identifier indicating information about the physical mail. A presence of the physical mail is detected in the mailbox. The identifier is read in response to detecting the presence of the physical mail. A notification is sent to a mail recipient including the information in response to reading the identifier.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the illustrative embodiments may be implemented;

FIG. 2 is a block diagram of a data processing system in which the illustrative embodiments may be implemented;

FIG. 3 is a block diagram of a remote mailbox notification system in accordance with the illustrative embodiments; and

FIG. 4 is a flowchart of a process for generating a notification from a remote mailbox in accordance with the illustrative embodiments.

### DETAILED DESCRIPTION OF THE PREFERRED EMBODIMENT

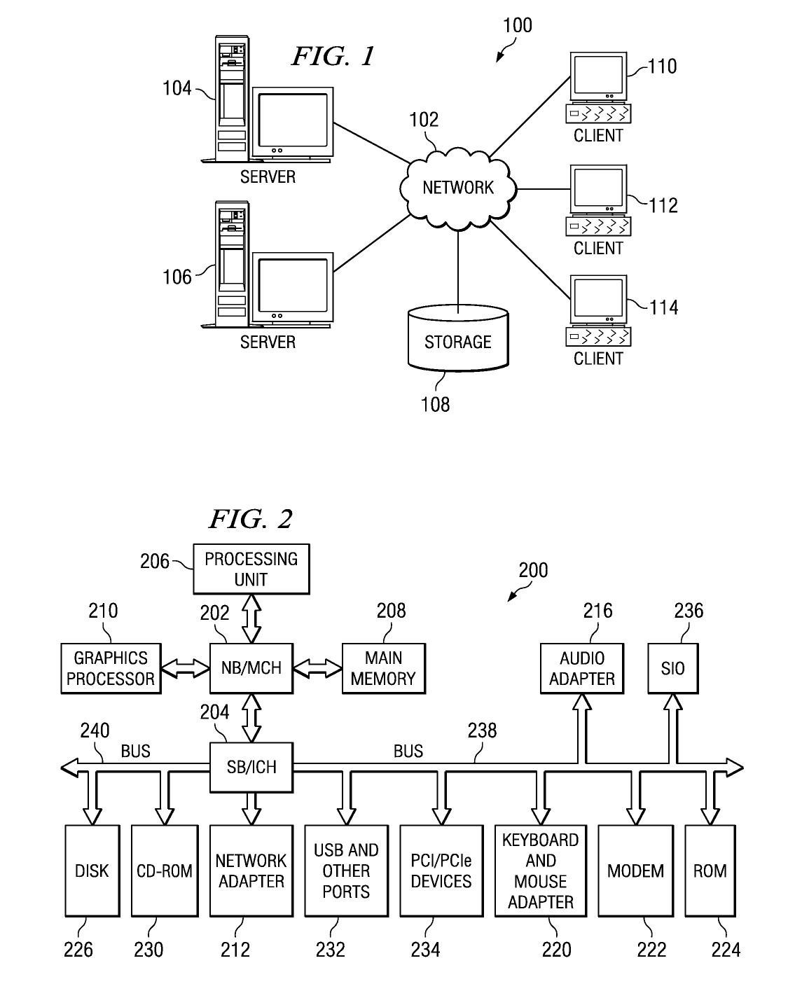

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, apparatus, and computer usable program code for notification of mail deliveries in a remote post office mailbox. All mail received by the mailbox in physical form in the illustrative embodiments is physical mail and referred to as mail. Electronic mail is referred to separately as email. In one embodiment, a remote mailbox sends a notification to the mail recipient that mail has been received. The notification is an email message, phone call, instant message, page, or other electronic communication indicating the presence of mail.

In some cases, the notification additionally specifies a priority or importance and mail content information. Sending of the notification to the mail recipient may be initiated using different mechanism, such as for example, by the mail delivery personnel, motion sensor, or electronic scale. The mail recipient may be notified using a receiver. The receiver may be, for example, a personal computer, personal digital assistant (PDA), cell phone, or other computing device.

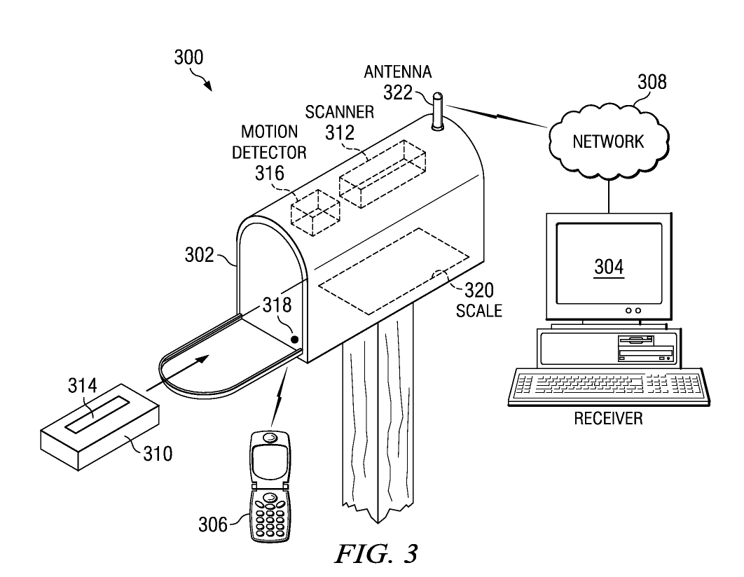

Turning next to FIG. 3, a block diagram of a remote mailbox notification system is depicted in accordance with the illustrative embodiments. Remote mailbox management system 300 includes various communicating components including mailbox 302, receiver 304, and cell phone 306. The various components may communicate via network 308. Network 308 may be a network, such as network 102 of FIG. 1.

Mailbox 302 may include numerous elements allowing the mail recipient to receive a notification in receiver 304 or cell phone 306 or other similar computing device that mail 310 has been delivered to mailbox 302. The presence of mail 310 may be detected using any number of techniques as described herein. Mailbox 302 may receive multiple pieces of mail in assorted forms. Mail 310 may be a postcard, letter, package, or other deliverable physical mail content.

In one illustrative embodiment, mailbox 302 includes scanner 312 for scanning electronic identification label 314 on mail 310. Electronic identification label 314 is an identifier or label that provides information to mailbox 302 and subsequently to a mail recipient. Information extracted or identified from electronic identification label 314 is information or data regarding the contents and importance of each piece of mail. Scanner 312 may use radio frequencies, optical character recognition, bar codes, or other techniques for extracting embedded information from electronic identification label 314. Electronic identification label 314 may be a printed label or an electronic label that specifies information about each piece of mail.

Electronic identification label 314 may be, for example, a radio frequency identification tag, bar code, text, or other identifier for storing information in mail 310. Scanner 312 may use radio frequencies, optical character recognition, bar codes, or other techniques for identifying embedded information from electronic identification label 314. In these examples, each piece of mail may be scanned individually or as a group as placed in mailbox 302.

In one illustrative embodiment, electronic identification label 314 is a radio frequency identification (RFID) tag that is part of mail 310 and scanner 312 is a radio frequency identification tag reader. Electronic identification label 314 is an automatic device that transmits a predetermined message indicating that mail 310 has been placed in mailbox 302 in response to receiving a predefined signal from scanner 312. The radio frequency identification tag may be a passive radio frequency identification tag that receives, amplifies, and retransmits a signal on a different frequency back to scanner 312. Passive radio frequency identification tags may include a minute antenna, integrated circuit, and memory. For example, the minute electrical current induced in an antenna of a radio frequency identification tag by the incoming radio frequency signal provides just enough power for a CMOS integrated circuit (IC) in the tag to power up and transmit a response.

Electronic identification label 314 stores information that is returned to scanner 312 when read. Electronic identification label 314 includes information regarding the contents and importance of each piece of mail. For example, electronic identification label 314 may specify a sending party or sender and a dollar value associated with mail 310. The user may be notified via receiver 304 or cell phone 306 when the summed value for each piece of mail exceeds a specified threshold, such as fifty dollars.

Electronic identification label 314 may be used to inform the mail delivery person that mail 310 is in the correct mailbox or to verify that the mail is addressed to the proper party to prevent incorrect mail deliveries. For example, if electronic identification label 314 specifies an intended mail recipient that is different from a person or name linked with mailbox 302 the mail delivery person is alerted of the difference.

Alternatively, the mail recipient may specify a priority for different types of mail so that a mail notification message is sent only when mail 310 is deemed sufficiently important. For example, a pay check from a client may have a high priority, and mailbox 302 may immediately send a mail notification to receiver 304 when the pay check is scanned by scanner 312. The mail recipient may specify the priority by setting preferences for mailbox 302. In another example, a credit report may inherently be assigned a high importance/priority by the sender.

Scanner 312 may also be used as an authentication device. For example, only a user, such as an authorized mail delivery person or the mail recipient, may have a radio frequency identification tag that verifies access rights. In one example, if an individual without the required radio frequency identification tag accesses mailbox 302, an alarm sounds and/or a violation notification is sent to the appropriate authority and mail recipient. The mail delivery person may have a key that provides access to all mailboxes or designated mailboxes. A locking mechanism may prevent access to mailbox 302 or a slit in mailbox 302 without the proper authentication.

Mailbox 302 may also include motion detector 316. Motion detector 316 is a motion sensing device that indicates that mailbox 302 has been accessed. Motion detector 316 may use infrared, magnetic, or optical sensors to indicate that mail 310 has been inserted into mailbox 302.

Mailbox 302 may also include indicator 318. Indicator 318 is an affirmative indicator activated by the mail delivery person when mail 310 is placed in mailbox 302. For example, indicator 318 may be a button, switch, touch screen, or other device allowing the mail delivery person to indicate the presence of mail 310 in mailbox 302.

Mailbox 302 may also include scale 320. Scale 320 is a weight measurement device. Scale 320 may be set to send a mail notification based on the weight presence of mail 310 within mailbox 302. Scale 320 may use a threshold value or a default value of zero pounds/kilograms. For example, the threshold value may be set for two pounds. Once the mail contents reach that weight threshold, a mail notification message is sent. Mailbox 302 may include one or more of the following devices or detectors for detecting the presence of mail 310 including motion detector 316, scale 320, scanner 312, and indicator 318.

In one illustrative embodiment, mailbox 302 transmits the mail notification to receiver 304 or cell phone 306 via wireless antenna 322. In another illustrative embodiment, mailbox 302 is hard wired to network 308 by a phone line, Ethernet connection, or other communication medium for transmitting the mail notification. The mail notification may be stored in receiver 304 or cell phone 306.

The information from electronic identification label 314 and the mail notification may be streamed in various forms to receiver 304. In one example, the information is sent via email to receiver 304. In another example, the information is updated to a mail program application executed on receiver 304.

Mailbox 302 or scanner 312 may include memory for storing information regarding the contents of mail 310 read from electronic identification label 314. Mailbox 302 may store a preferred email address, instant messaging identification, or other contact information for the recipient for automatically sending the mail notification and information from electronic identification label 314. Additionally, when the mail recipients open mailbox 302, the information stored by mailbox 302 regarding the contents of mail 310 may be synchronized to a receiving device, such as cell phone 306. In one example, the mailbox may communicate with cell phone 306, a Bluetooth enabled device, via wireless antenna 322. Mailbox 302 may use other similar transmission protocols, such as 802.11b or 802.11g for uploading information to cell phone 306 or other handheld computing devices.

While delivering messages to mailbox 302, the postmaster or mail delivery person may read radio frequency identification tags or electronic labels on mail using a reader. The reader reads and stores the information from mail 310 from electronic identification label 314. The reader may also extract a related email address from a mailbox radio frequency identification tag or scanner 312. Later, the reader sends an email message or other communication to receiver 304, cell phone 306, or other registered device.

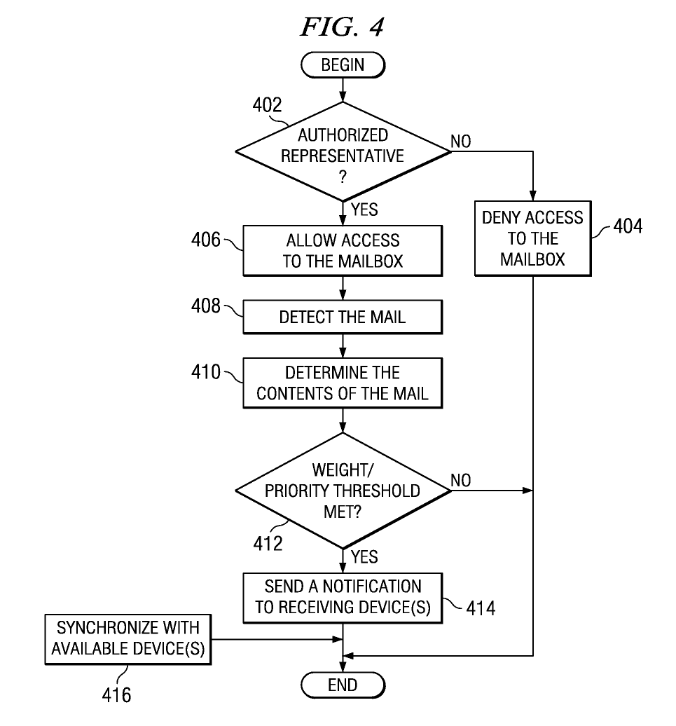

With reference next to FIG. 4, a flowchart of a process for generating a notification from a remote mailbox is depicted in accordance with the illustrative embodiments. The process of FIG. 4 may be implemented by mailbox 302 of FIG. 3. The process begins by determining whether a person seeking access to the mailbox is an authorized representative (step 402). In one example, the authorized representative may have a radio frequency identification tag or electronic identification label similar to electronic identification label 314 of FIG. 3 that grants the individual access to the mailbox. If the mailbox determines the individual is not an authorized representative, the mailbox denies access to the mailbox (step 404) with the process terminating thereafter.

If the mailbox determines the individual is an authorized representative in step 402, the mailbox allows access to the mailbox (step 406). For example, the mailbox may release a locking mechanism so that a door to the mailbox may be opened. Next, the mailbox detects the mail (step 408). The mail may be one or more pieces of mail, such as mail 310 of FIG. 3. The mailbox may detect the mail using motion detector 316, scale 320, scanner 312, or indicator 318 all of FIG. 3.

Next, the mailbox determines the contents of the mail (step 410). In one illustrative embodiment, the mailbox uses electronic identification label 314 to determine the contents of the mail. For example, the electronic identification label may specify the contents of the mail and a priority.

Next, the mailbox determines if the weight/priority threshold is met (step 412). The weight may be determined by scale 320 of FIG. 3. The priority may be associated with a priority or other information stored within electronic identification label 314 of FIG. 3. The mail recipient may establish the priority, delivery, and notification options and retrieval information for each piece of mail by setting user preferences associated with the mailbox. For example, the mail recipient may use a computing device and a browser to set preferences that are stored in the mailbox.

The determination of step 412 may be made based on a threshold value for weight and urgency. The mailbox may query a price lookup service or database to determine the total value of the mail for making the determination of step 412.

If the mailbox determines the weight/priority threshold is not met, the process terminates. If the mailbox determines the weight/priority threshold is met in step 412, the mailbox sends a notification to receiving device(s) (step 414) with the process terminating thereafter. The mail notification may be sent to receiving devices, such as receiver 304 and cell phone 306 both of FIG. 3. The receiving device may, in these examples, be mobile devices, such as a laptop, cell phone, or personal digital assistant.

Independently, when the mail recipient accesses the mailbox, the mailbox synchronizes with available device(s) (step 416) with the process terminating thereafter. In these examples, the mailbox may synchronize via Bluetooth with cell phone 306 of FIG. 3.

Thus, the illustrative embodiments provide for a computer implemented method, apparatus, and computer usable program code for automatic notification of mail deliveries in a remote post office mailbox. A mail recipient may be notified by an indicator selected by a mail delivery person, scanner, scale, or motion sensor within the mailbox that mail has been received. As a result, the mail recipient may more quickly access important information.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for mail notification, the computer implemented method comprising:
receiving physical mail in a mailbox, wherein the physical mail includes an identifier indicating information about the physical mail;
detecting a presence of the physical mail in the mailbox;
responsive to detecting the presence of the physical mail, reading the identifier; and
responsive to reading the identifier, sending a notification to a mail recipient including the information.

2. The computer implemented method of claim 1, further comprising:
detecting an attempt by a person to access the mailbox;
responsive to detecting the attempt, determining if the person seeking access to the mailbox is authorized to access the mailbox.

3. The computer implemented method of claim 2, further comprising:
responsive to a determination that the person seeking access to the mailbox is authorized to access the mailbox, granting access to the mailbox; and
responsive to the determination that the person seeking access to the mailbox is not authorized to access the mailbox, denying access to the mailbox.

4. The computer implemented method of claim 1, wherein the identifier is a radio frequency identification tag.

5. The computer implemented method of claim 1, the reading step is performed at a time of delivery of the physical mail.

6. The computer implemented method of claim 1, further comprising:
determining whether a mail recipient indicated by the identifier is the same as an intended mail recipient associated with the mailbox for preventing incorrect deliveries;
responsive to the mail recipient indicated by the identifier being different from the intended mail recipient associated with the mailbox, alerting a mail delivery person of the difference.

7. The computer implemented method of claim 3, wherein the granting step is performed if the physical mail is addressed to a person seeking access to the mailbox.

8. The computer implemented method of claim 1, wherein the detecting step is performed by any of a motion detector, scale, scanner, and indicator.

9. The computer implemented method of claim 1, further comprising:
performing the sending step based on a value of the physical mail in the mailbox by querying a price lookup service to determine a total value of the physical mail.

10. The computer implemented method of claim 1, further comprising:
performing the sending step based on an importance of the physical mail in the mailbox, wherein the importance is specified by a user preference.

11. The computer implemented method of claim 1, wherein the user preference is any of value, weight, sender, and type of physical mail, and wherein the mailbox is in a remote location to a location of the mail recipient.

12. The computer implemented method of claim 1, further comprising:
storing the information in the mailbox;
responsive to the mail recipient accessing the mailbox, synchronizing the information with a receiving device.

13. A physical mail notification system comprising:
a mailbox for receiving physical mail wherein the mailbox includes:
a reader for reading an identifier on the physical mail to identify information about the physical mail when the physical mail is placed in the mailbox;
a detector for detecting the physical mail in the mailbox; and
a first client operatively connected to the mailbox, wherein the mailbox sends a physical mail receipt notification to the first client;
a second client operatively connected to the mailbox wherein the mailbox synchronizes the information from the physical mail with the second client when the mailbox is accessed.

14. The system of claim 13, wherein the detector is any of a motion detector, scale, scanner, and indicator.

15. The system of claim 13, wherein the mailbox stores the information and user preferences for accessing the information and the physical mail.

16. The system of claim 13, wherein the first client is a personal computer, and wherein the second client is a mobile device.

17. A computer program product comprising a computer usable medium including computer usable program code for mail notification, the computer program product comprising:
computer usable program code for receiving physical mail in a mailbox, wherein the physical mail includes an identifier indicating information about the physical mail;
computer usable program code for detecting a presence of the physical mail in the mailbox;
computer usable program code responsive to detecting the presence of the physical mail, for reading the identifier; and
computer usable program code responsive to reading the identifier, for sending a notification to a mail recipient including the information.

18. The computer program product of claim 17, comprising computer usable program code for reading the identifier at a time of delivery of the physical mail using a radio frequency identification tag, wherein the identifier is the radio frequency identification tag.

19. The computer program product of claim 17, wherein the computer usable program code for sending the notification to the mail recipient including the information is performed based on an importance of the physical mail in the mailbox as established by the information or user preference.

20. The computer program product of claim 17, the computer usable program code for detecting is based on input from any of a motion detector, scale, scanner, and indicator.
